(19) United States
(12) Patent Application Publication
(10) Pub. No.: US 2016/0361953 A1
(43) Pub. Date: Dec. 15, 2016

(54) PNEUMATIC TIRE

(71) Applicant: TOYO TIRE & RUBBER CO., LTD., Osaka (JP)

(72) Inventor: Tsuyoshi Fujioka, Osaka-shi (JP)

(73) Assignee: TOYO TIRE & RUBBER CO., LTD., Osaka (JP)

(21) Appl. No.: 15/161,817

(22) Filed: May 23, 2016

(30) Foreign Application Priority Data
Jun. 15, 2015 (JP) 2015-120346

(51) Int. Cl. B60C 11/03; B60C 11/13; B60C 11/12

(52) U.S. Cl. CPC B60C 11/0332; B60C 11/0309; B60C 11/032; B60C 11/125; B60C 11/1259; B60C 11/1307; B60C 2011/1254; B60C 2011/0341; B60C 2011/0367; B60C 2011/1338; B60C 2011/0334

(57) ABSTRACT

A pneumatic tire including a plurality of main grooves extending in a tire circumference direction and a land portion interposed between the main grooves being segmentalized by a plurality of lateral grooves to form a plurality of blocks arranged in the tire circumference direction, wherein the block includes a first protruding portion protruding from a portion on one side in a tire width direction to one side in the tire circumference direction and a second protruding portion protruding from a portion on the other side in the tire width direction to the other side in the tire circumference direction, and the second protruding portion of the block on the one side and the first protruding portion of the block on the other side overlap with each other in the tire circumference direction between the blocks adjacent to each other in the tire circumference direction.

### CROSS REFERENCE OF RELATED APPLICATION

This application is based upon and claims the benefit of priority of the prior Japanese Patent Application No. 2015-120346 (applied Jun. 15, 2015), the entire contents of which are incorporated herein by reference.

### BACKGROUND OF THE INVENTION

1. Field of the Invention

The present invention relates to a pneumatic tire.

2. Related Art

A plurality of main grooves extending in a tire circumference direction segmentalize a tread to form a center land portion inside in a tire width direction and shoulder land portions outside in the tire width direction. Depending on the tires, a center portion is formed into a rib continuing in the tire circumference direction. In contrast, as described in Japanese Patent No. 4149219 and Japanese Patent No. 4330561, there is a tire in which the center portion is segmentalized by a plurality of lateral grooves extending in the tire width direction to form a block row.

The tire having the block row includes the lateral grooves, and thus tends to have excellent traction properties. In particular, if the lateral grooves are deep, the lateral grooves remain being deep even though wear of the tread has become advanced, and the traction properties are ensured.

However, the blocks are low in rigidity and thus are more likely to move compared with a rib continuing in the tire circumference direction in some cases, and the tire having the block row may be poor in wear-resistance properties and uneven-wear-resistance properties in some cases. In particular, in the case where the lateral grooves are deep, the wear-resistance properties and the uneven-wear-resistance properties are more likely to become poor. In this manner, in the related art, achievement of both of traction properties and wear-resistance properties or uneven-wear-resistance properties is difficult.

### SUMMARY

Accordingly, it is an object of the invention to provide a pneumatic tire having excellent traction properties and, in addition, having excellent wear-resistance properties and uneven-wear-resistance properties.

A pneumatic tire of an embodiment is a pneumatic tire including a plurality of main grooves extending in a tire circumference direction and a land portion interposed between the main grooves being segmentalized by a plurality of lateral grooves to form a plurality of blocks arranged in the tire circumference direction, in which the blocks each include a first protruding portion protruding from a portion on one side in a tire width direction to one side in the tire circumference direction, and a second protruding portion protruding from a portion on the other side in the tire width direction to the other side in the tire circumference direction, and the blocks adjacent to each other in the tire circumference direction are arranged in such a manner that the second protruding portion of the block on the one side and the first protruding portion of the block on the other side overlap with each other in the tire circumference direction.

The pneumatic tire of the embodiment has excellent traction properties and has excellent wear-resistance properties and uneven-wear-resistance properties.

### BRIEF DESCRIPTION OF DRAWINGS

FIG. 1 is a drawing illustrating a tread pattern of a pneumatic tire of an embodiment;

FIG. 2 is a cross-sectional view taken along line A-A in FIG. 1;

FIG. 3 is a tread pattern of a pneumatic tire of Example 2; and

FIG. 4 is a tread pattern of a pneumatic tire of Comparative Example 1.

### DETAIL DESCRIPTION OF INVENTION

A pneumatic tire 10 of an embodiment is provided with bead portions on both sides in a tire width direction, and carcasses are folded back from inside to outside in the tire width direction to envelope the bead portions and forming a framework of the pneumatic tire 10. The carcass is provided with a belt layer and a belt reinforcing layer outside in the tire radius direction, and a tread 20 is provided outside in a tire radius direction. Side walls are provided on both sides of the carcass in the tire width direction. In addition to these members, a plurality of members depending on requirements in terms of functions of the tire are also provided.

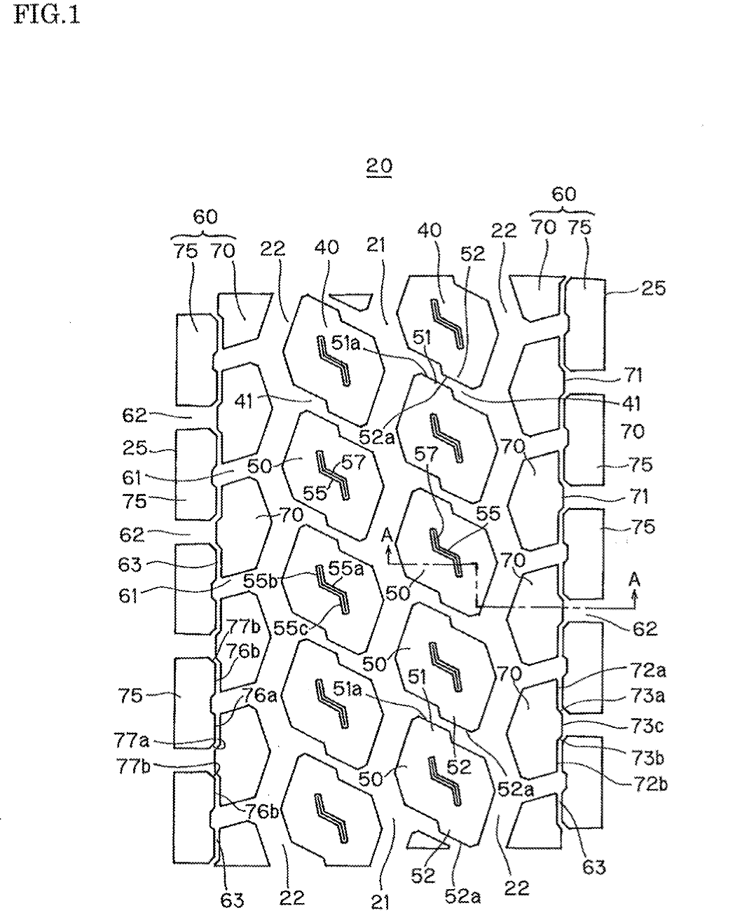

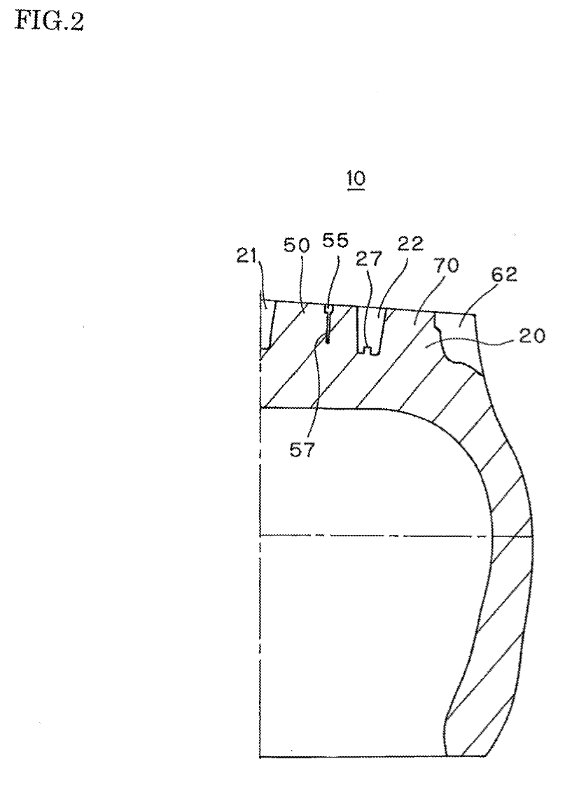

As illustrated in FIG. 1, the tread 20 of the embodiment is provided with three main grooves extending in a tire circumference direction. One of the three main grooves is a main groove 21 provided along a tire equator, and remaining two main grooves are main grooves 22 and 22 provided on both sides in the tire width direction. These main grooves 21, 22 and 22 have a zigzag pattern, and extend in the tire circumference direction. Angular portions of the zigzag patterns of the main grooves 21, 22 and 22 are shifted from each other in the tire circumference direction. A land portion of the tread 20 is segmentalized into a center portion in the tire width direction interposed between the main grooves 22 and 22 on both sides in the tire width direction and shoulder land portions 60 and 60 interposed between the main grooves 22 and tire ground contact ends 25 on both sides in the tire width direction. The center portion in the tire width direction is segmentalized by the main groove 21 extending along the tire equator into two center land portions 40 and 40 arranged in the tire width direction. As illustrated in FIG. 2, a small projection 27 configured to prevent stone catching is preferably provided on the groove bottom of each of the main grooves 22. A projecting height of the small projection 27 from the groove bottom is lower than the depth of the main grooves 22. Preferably, a plurality of the small projections 27 are provided and arranged in the direction of extension of the main grooves 22. Preferably, the small projections 27 are provided also in the main groove 21 extending along the tire equator.

By the tire ground contact ends 25 is meant ground contact ends in the tire width direction in a state in which the pneumatic tire 10 is assembled to a proper rim, is set to a proper inner pressure, and is applied with a proper load. By the proper rim is meant a standard rim specified by standards such as JATMA, TRA, ETRTO, and the like. By the proper load is meant a maximum load determined by the standard. By the proper inner pressure is meant an inner pressure corresponding to the maximum load.

The center land portions 40 are segmentalized by a plurality of center lateral grooves 41 extending in the tire width direction (when the term “tire width direction” is used for expressing the direction in which the grooves extend, the term includes not only a direction parallel to the tire width direction, but also directions at a slope with respect to the tire width direction). The center lateral grooves 41 are arranged equidistantly in the tire circumference direction. The center lateral grooves 41 connect angular portions of the zigzag patterns of the main grooves 21 and 22 on both sides of the center land portions 40 and extend at a slope with respect to the tire width direction. A depth of the center lateral grooves 41 is preferably not smaller than 70% of the depth of the main grooves 21 and 22.

Two of the center lateral grooves 41 and 41 and two of the main grooves 21 and 22 arranged in the tire circumference direction constitute a center block 50. A plurality of the center blocks 50 having the same shape are arranged equidistantly in the tire circumference direction, and form a block row.

Each of the center blocks 50 includes a first protruding portion 51 protruding from a portion on one side (left side in FIG. 1) in the tire width direction to one side (upper side in FIG. 1) in the tire circumference direction and a second protruding portion 52 protruding from a portion on the other side (right side in FIG. 1) in the tire width direction to the other side (lower side in FIG. 1) in the tire circumference direction, and has a substantially S-shape as a whole. The first protruding portion 51 and the second protruding portion 52 project inward of the center lateral grooves 41 and reduce the width of the center lateral grooves 41. By the width of a groove is meant a length of the groove in a direction orthogonal to a direction of extension of the groove. The center blocks 50 and 50 adjacent to each other in the tire circumference direction are arranged in such a manner that the second protruding portion 52 of the center block 50 on the one side and the first protruding portion 51 of the center block 50 on the other side overlap with each other in the tire circumference direction. Therefore, the center lateral grooves 41 are each narrowed in width at a portion where the second protruding portion 52 of the center block 50 on the one side and the first protruding portion 51 of the center block 50 on the other side overlap with each other in the tire circumference direction compared with other portions. In the embodiment, a top area (an end in a direction of the width of the center lateral groove 41) 51a of the first protruding portion 51 and a top area (the same as above) 52a of the second protruding portion 52 extend in a linear fashion at a slope with respect to the tire width direction, and extend in parallel to each other with the center lateral groove 41 interposed therebetween.

With the structure described above, when a force in the tire circumference direction is applied to the center land portions 40, the top areas 52a of the second protruding portions 52 of the center blocks 50 on the one side in the tire circumference direction and the top areas 51a of the first protruding portions 51 of the center blocks 50 on the other side in the tire circumference direction come into contact with each other, and the center lateral grooves 41 are closed at the corresponding contact portions. Accordingly, the center blocks 50 and 50 arranged in the tire circumference direction support each other.

As illustrated in FIG. 1 and FIG. 2, the center blocks 50 each include a center narrow groove 55 closed at both ends thereof formed therein. The center narrow groove 55 includes a first narrow groove 55a at a center of the center block 50, a second narrow groove 55b extending from an end of the first narrow groove 55a on one side (upper side in FIG. 1) and a third narrow groove 55c extending from an end of the first narrow groove 55a on the other side (lower side in FIG. 1). The second narrow groove 55b and the third narrow groove 55c extend in opposite directions from both ends of the first narrow groove 55a. Accordingly, the center narrow groove 55 has a substantially S-shape which follows the shape of the center block 50 as a whole. The first narrow groove 55a, the second narrow groove 55b, and the third narrow groove 55c extend at a slope with respect to the tire width direction and the tire circumference direction. The center narrow groove 55 preferably overlaps with both of the first protruding portion 51 and the second protruding portion 52 in the tire circumference direction. The center narrow groove 55 includes a sipe 57 formed on the groove bottom thereof. The sipe 57 has the same shape as the center narrow groove 55 when viewed from outside in the tire radius direction, and has a width smaller than that of the center narrow groove 55. A depth of the center narrow groove 55 preferably falls within a range from 5% to 20% of a depth of the main grooves 21 and 22. In addition, a depth of the sipe 57 preferably falls within a range from 40% to 90% of a depth obtained by subtracting the depth of the center narrow groove 55 from the depth of the main grooves 21 and 22.

The shoulder land portions 60 each include first shoulder lateral grooves 61 and second shoulder lateral grooves 62. The first shoulder lateral grooves 61 extend at a slope with respect to the tire width direction, and ends thereof located inside in the tire width direction open toward angular portions of the zigzag pattern of the main grooves 22, and ends located outside in the tire width direction are closed in the shoulder land portions 60. The second shoulder lateral grooves 62 extend in the tire width direction, and ends located inside in the tire width direction are closed in the shoulder land portions 60, and ends located outside in the tire width direction reach the tire ground contact end 25. The first shoulder lateral grooves 61 and the second shoulder lateral grooves 62 are arranged equidistantly in the tire circumference direction. The first shoulder lateral grooves 61 and the second shoulder lateral grooves 62 are arranged alternately in the tire circumference direction. Preferably, the depths of the first shoulder lateral grooves 61 and the second shoulder lateral grooves 62 are not smaller than 70% of the depth of the main grooves 21 and 22. Each of the shoulder land portions 60 is further provided with a shoulder narrow groove 63 extending in the tire circumference direction. The shoulder narrow groove 63 has a constant width in a range where blocks exist on both sides thereof. Preferably, a depth of the shoulder narrow groove 63 falls within a range from 20% to 40% of the depth of the main grooves 21 and 22. The shoulder narrow groove 63 opens at positions in the vicinity of ends of the first shoulder lateral grooves 61 within the shoulder land portion 60 and also opens at positions in the vicinity of ends of the second shoulder lateral grooves 62 within the shoulder land portion 60. The shoulder narrow groove 63 extends in the tire circumference direction while being bent at some points in order to achieve the opening state as described above.

The main groove 22, the shoulder narrow groove 63 and two of the first shoulder lateral grooves 61 and 61 arranged in the tire circumference direction form a first shoulder block 70. The shoulder narrow groove 63, the tire ground contact end 25, and two of the second shoulder lateral grooves 62 and 62 arranged in the tire circumference direction form a second shoulder block 75. A plurality of the first shoulder blocks 70 having the same shape and a plurality of the second shoulder blocks 75 having the same shape are arranged equidistantly in the tire circumference direction to form block rows, respectively. The first shoulder blocks 70 and the second shoulder blocks 75 are arranged alternately in the tire circumference direction. The first shoulder blocks 70 and the second shoulder blocks 75 overlap with each other in the tire width direction.

The first shoulder blocks 70 each include a protruding portion 71 protruding toward the second shoulder block 75 near a center thereof in the tire circumference direction. The protruding portion 71 protrudes toward a space between two of the second shoulder blocks 75 and 75 arranged in the tire circumference direction. On both sides of the protruding portion 71 in the tire circumference direction, ends of the first shoulder block 70 located outside in the tire circumference direction are linear first opposing portions 72a and 72b extending in the tire circumference direction. The first opposing portions 72a and 72b oppose the second shoulder blocks 75. The protruding portion 71 includes first slopes 73a and 73b continuing from the first opposing portions 72a and 72b and extending at a slope in the tire width direction with respect to the first opposing portions 72a and 72b. The first slopes 73a and 73b of the protruding portion 71 are formed by the above-described bent portions of the shoulder narrow groove 63. A top area 73c of the protruding portion 71 is formed by an end of the second shoulder lateral groove 62 located inside in the tire width direction.

The second shoulder block 75 includes second opposing portions 76a and 76b opposing the first opposing portions 72a and 72b of the first shoulder blocks 70 with the shoulder narrow groove 63 interposed therebetween. The second opposing portions 76a and 76b extend linearly in the tire circumference direction. The second shoulder blocks 75 each include second slopes 77a and 77b opposing the first slopes 73a and 73b with the shoulder narrow groove 63 interposed therebetween. The second slopes 77a and 77b extend at a slope with respect to the tire circumference direction. An angle of slope of the first slopes 73a and 73b and the second slopes 77a and 77b with respect to the tire circumference direction is the same.

Characteristics of the shapes of the first shoulder block 70 and the second shoulder block 75 are common to both sides in the tire width direction.

The protruding portion 71 of the first shoulder block 70 overlaps in the tire circumference direction with the second shoulder blocks 75 and 75 on both sides thereof in the tire circumference direction at least when being grounded. In other words, in a state in which the pneumatic tire 10 is not grounded, the protruding portion 71 may overlap with the second shoulder blocks 75 and 75 in the tire circumference direction. The protruding portion 71 does not have to overlap with the second shoulder blocks 75 and 75 in the tire circumference direction in a state in which the pneumatic tire 10 is not grounded as long as the protruding portion 71 overlaps with the second shoulder blocks 75 and 75 in the tire circumference direction in a state in which the pneumatic tire 10 is grounded. Here, it is assumed that the pneumatic tire 10 is assembled to a proper rim, is set to a proper inner pressure, and is applied by a proper load at the time of being grounded. The proper rim, the proper inner pressure, and the proper load are defined above.

In this structure, when a force in the tire circumference direction is applied to the shoulder land portions 60 at the time of being grounded, parts of the shoulder narrow grooves 63 where the first slopes 73a and 73b of the protruding portions 71 of the first shoulder blocks 70 and the second slopes 77a and 77b of the second shoulder blocks 75 oppose each other are closed. In other words, the protruding portions 71 of the first shoulder blocks 70 each engage the second shoulder blocks 75 and 75 on both sides thereof in the tire circumference direction. Accordingly, the protruding portion 71 of the first shoulder block 70 and the second shoulder blocks 75 and 75 support each other in the tire circumference direction.

When a force in the tire width direction is applied to the shoulder land portions 60, parts of the shoulder narrow grooves 63 where the first opposing portions 72a and 72b of the first shoulder blocks 70 and the second opposing portions 76a and 76b of the second shoulder blocks 75 oppose each other are closed, and furthermore, parts where the first slopes 73a and 73b of the protruding portions 71 of the first shoulder blocks 70 and the second slopes 77a and 77b of the second shoulder blocks 75 oppose each other are also closed. In other words, the first shoulder blocks 70 each engage the second shoulder blocks 75 and 75 on both sides thereof in the tire circumference direction. Accordingly, the first shoulder block 70 and the second shoulder blocks 75 and 75 support each other in the tire width direction.

The center blocks 50, the first shoulder blocks 70, and the second shoulder block 75 of the respective block rows are shifted from each other in the tire circumference direction, but are arranged at regular pitches. A total sum of ground contact surface areas of the center land portions 40 and a total sum of ground contact surface areas of the shoulder land portions 60 are substantially equivalent, and the difference therebetween is preferably within 5%.

The pneumatic tire 10 having the structure as described above is provided with the center lateral grooves 41 formed in the center land portions 40 to form the block rows of the center blocks 50, and thus has excellent traction properties. In particular, in the case where the center lateral grooves 41 have a depth not smaller than 70% of the depth of the main grooves 21 and 22, the center lateral grooves 41 remain being deep even though wear of the tread 20 has become advanced, and thus the traction properties are ensured.

In addition, the center blocks 50 each include the first protruding portion 51 protruding in the one side in the tire circumference direction and the second protruding portion 52 protruding on the other side in the tire circumference direction, so that the second protruding portion 52 of the center block 50 on one side and the first protruding portion 51 of the center block 50 on the other side overlap with each other in the tire circumference direction between the blocks adjacent to each other in the tire circumference direction. Therefore, as described above, when a force in the tire circumference direction is applied to the center land portions 40, the second protruding portion 52 and the first protruding portion 51 opposing each other come into contact with each other, and thus the center blocks 50 and 50 arranged in the tire circumference direction support each other. Therefore, the center blocks 50 and 50 do not deform significantly and thus wear and uneven wear are reduced.

In addition, since the first protruding portion 51 protrudes from the center block 50 on the one side in the tire width direction and the second protruding portion 52 protrudes from the center block 50 on the other side in the tire width direction, so that the center blocks 50 have uniform rigidity in the tire width direction. Therefore, uneven wear is reduced.

As described above, the pneumatic tire 10 has excellent traction properties and, in addition, has excellent wear-resistance properties and uneven-wear-resistance properties.

The center blocks 50 are each provided with the center narrow groove 55 closed at both ends thereof and the sipe 57 is formed at the groove bottom of the center narrow groove 55. Therefore, in the initial state of wear, the center narrow groove 55 contributes to ensure traction properties and side skid resistance properties, and from a mid-stage of wear onward in which the wear has become advanced, the sipe 57 contributes to ensure traction properties and side-skid-resistance properties. Here, the center narrow groove 55 does not extend to a deep position, but the center narrow groove 55 extends to a certain depth position and then the sipe 57 having a narrower width continues to a deeper portion. Therefore, rigidity of the entire portion of the center block 50 is ensured and thus wear-resistance properties are ensured.

Here, if the depth of the center narrow grooves 55 is not smaller than 5% of the depth of the main grooves 21 and 22, excellent traction properties and side-skid-resistance properties are achieved specifically in the initial stage of wear. In addition, if the depth of the center narrow grooves 55 is not larger than 20% of the depth of the main grooves 21 and 22, movement of the center blocks 50 is reduced and thus wear and uneven wear are reduced. Here, if the depth of the sipes 57 is not smaller than 40% of the depth obtained by subtracting the depth of the center narrow groove 55 from the depth of the main grooves 21 and 22, excellent traction properties and side-skid-resistance properties are achieved especially from the mid stage of wear onward in which the wear has become advanced. Furthermore, if the depth of the sipes 57 is not larger than 90% of the depth obtained by subtracting the depth of the center narrow grooves 55 from the depth of the main grooves 21 and 22, movement of the center blocks 50 is reduced and thus wear and uneven wear are reduced.

In the case where the center blocks 50 each include the center narrow groove 55 overlapping with the first protruding portion 51 and the second protruding portion 52 in the tire circumference direction, since the center narrow groove 55 is closed when a force is applied from the first protruding portion 51 and the second protruding portion 52 to the center block 50 in the tire circumference direction, movement of the entire center block 50 is reduced and thus wear and uneven wear are reduced.

The shoulder land portions 60 of the above-described embodiment each include the first shoulder blocks 70 on the main groove 22 side and the second shoulder blocks 75 on the tire ground contact end 25 side arranged alternately in the tire circumference direction, and the protruding portion 71 of each of the first shoulder blocks 70 overlaps in the tire circumference direction with the second shoulder blocks 75 on both sides in the tire circumference direction at least at the time of being grounded. Therefore, as described above, when a force in the tire circumference direction is applied to the shoulder land portions 60 at the time of being grounded, the protruding portions 71 of the first shoulder blocks 70 each engage the second shoulder blocks 75 on both sides thereof in the tire circumference direction, so that the first shoulder blocks 70 and the second shoulder blocks 75 support each other in the tire circumferential direction. Therefore, the first shoulder blocks 70 and the second shoulder blocks 75 do not deform significantly and thus wear and uneven wear are reduced.

Since the first shoulder blocks 70 and the second shoulder blocks 75 overlap each other in the tire width direction, when a force in the tire width direction is applied to the shoulder land portions 60, the first shoulder blocks 70 each engage the second shoulder blocks 75 on both sides thereof in the tire circumference direction, so that the corresponding members support each other in the tire width direction. Therefore, the first shoulder blocks 70 and the second shoulder blocks 75 do not deform significantly and thus wear and uneven wear are reduced.

Since the shoulder land portions 60 have such an effect in addition to the above-described effects of the center land portions 40, the pneumatic tire 10 has specifically excellent traction properties, wear-resistance properties, and uneven-wear-resistance properties.

If the difference between the total sum of the ground contact surface areas of the center land portions 40 and the total sum of the ground contact surface areas of the shoulder land portions 60 is within 5%, rigidities of the center land portions 40 and the shoulder land portions 60 are well balanced, and in addition, uneven wear is reduced.

The embodiment described thus far may be modified, replaced, and omitted variously without departing from the gist of the invention.

For example, the number of the main grooves is not limited to three as long as a plurality of the main grooves are provided. The shape of the main grooves is not limited to the zigzag pattern as those in the embodiment described above, and may be a straight pattern or a wavy pattern. The presence or absence of the slant of the lateral groove with respect to the tire width direction is not limited.

Therefore, various modifications are conceivable in the shape of the center block surrounded by the main grooves and the lateral grooves. For example, modifications in the shape of a portion of the center block without the first protruding portion and the second protruding portion include a rectangle, a parallelogram, and a trapezoid. Various modifications in the shapes of the first protruding portion and the second protruding portion of the center block are also conceivable. However, the shape of the center block in which top areas of the first protruding portion and the second protruding portion extend linearly and these top areas extend in parallel to each other is desirable because a large contact surface area is ensured between the first protruding portion and the second protruding portion. The shapes of the center blocks do not have to be all the same. The shapes of the center narrow grooves and the sipes formed in the center blocks are not limited to those in the embodiment described above. In the case of putting much value on traction properties, the center narrow grooves and the sipes may be configured to extend in the tire width direction. In contrast, in the case of putting much value on side-skid-resistance properties, the center narrow grooves and the sipes may be configured to extend in the tire circumference direction.

In the case where four or more of the main grooves are provided, mediate land portions are formed between the center land portion and the shoulder land portions in addition to the center land portions at a center in the tire width direction and the shoulder land portions located outside in the tire width direction. The mediate land portions may include blocks having the same shape as those of the center land portion in the embodiment described above.

The shape of the blocks of the shoulder land portions is not limited to those in the embodiment described above. The shoulder land portions may include a continuous rib continuing in the tire circumference direction instead of the blocks formed by the main grooves and the lateral grooves.

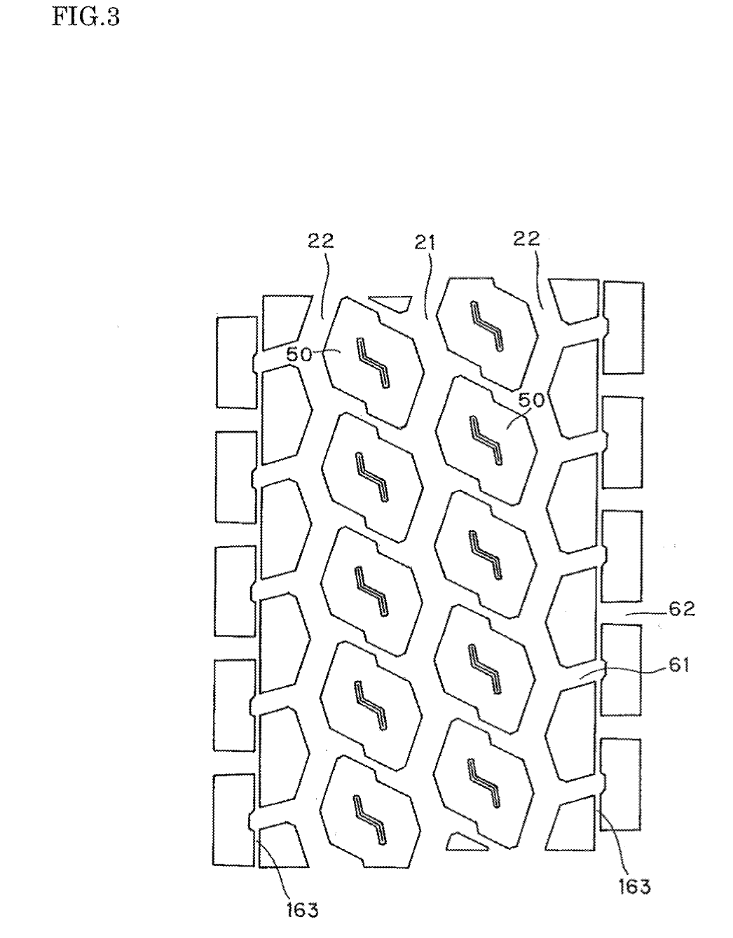

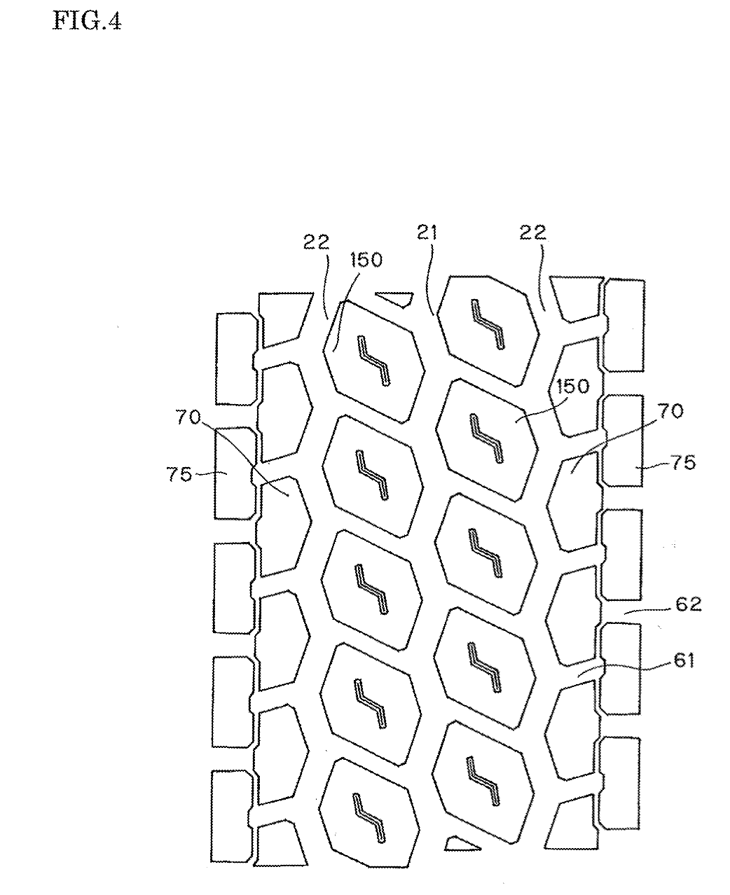

Evaluation on wear-resistance properties, uneven-wear-resistance properties, and traction properties of tires in Examples and Comparative Examples was conducted. A tread of the tire of Example 1 corresponds to the tread of the embodiment described above. A tread of the tires of Example 2 is illustrated in FIG. 3, which is different from that of Example 1 in that shoulder narrow grooves 163 extend linearly with no bend. A tread of the tire of Comparative Example 1 is illustrated in FIG. 4, in which a center block 150 does not include the first protruding portion and the second protruding portion. The widths and the depths of the main grooves of the tires are shown in Table 1. Dimensions in Table 1 are common to the tires of Comparative Example 1, Example 1, and Example 2. However, the center lateral grooves of Comparative Example 1 do not include portions where the first protruding portion and the second protruding portion overlap with each other in the tire circumference direction. All of the tires have a size of 11R22.5. The tires described above were mounted on a rim having a size of 22.5×7.50, were set to an internal pressure of 700 kPa, and were mounted on a vehicle having a load capacity of 10 t.

TABLE 1

| | Width | Depth |
|---|---|---|
| main groove | 16.7 mm | 23.6 mm |
| center lateral groove (portion where a | 9.7 mm | 18.9 mm |
| first protruding portion and a second | | |
| protruding portion do not overlap with each | | |
| other in a tire circumference direction) | | |
| center lateral groove (portion where a | 5.5 mm | 18.9 mm |
| first protruding portion and a second | | |
| protruding portion overlap with each other | | |
| in a tire circumference direction) | | |
| center narrow groove | 3.5 mm | 2.0 mm |
| sipe (a depth is a depth from a groove | 0.6 mm | 12.1 mm |
| bottom of a center narrow groove) | | |
| shoulder lateral groove | 11.2 mm | 23.6 mm |
| shoulder narrow groove | 2.8 mm | 7.7 mm |

Evaluation has been conducted as follows. All of indexes are relative indexes while letting a result of measurement of Comparative Example 1 be 100.

Wear-resistance properties: an amount of wear of the tread after travel of 20000 km was measured, and the result of measurement was indexed. The larger the index is, the lesser the wear occurs, and hence the more excellent the wear-resistance properties become.

Uneven-wear-resistance properties: an uneven-worn state of the tread after travel of 20000 km (an amount of heel-and-toe wear and a difference between an amount of wear of the center land portion and an amount of wear of the shoulder land portions) was measured, and the result of measurement was indexed. The larger the index is, the lesser the uneven wear occurs, and hence the more excellent the uneven-wear-resistance properties become.

Traction Properties: time required for the vehicle to travel 20 m from a stopped state on a road surface having a water depth of 1 mm in a state in which the land portions of the tread were worn by 70% was measured, and the result of measurement was indexed. The larger the index is, the lesser the required time becomes, and hence the more excellent the traction properties become.

The result of evaluation is as illustrated in Table 2. Numerical values shown in Table 2 are indexes described above, respectively. The tires in Examples 1 and 2 were confirmed to be excellent in wear-resistance properties, uneven-wear-resistance properties and traction properties compared with the tires in Comparative Example 1.

TABLE 2

| | | Compar- | | |
|---|---|---|---|---|
| | | ative | Exam- | Exam- |
| | | Example 1 | ple 1 | ple 2 |
| Charac- | Presence of overlap | No | Yes | Yes |
| teristics | between a first protruding | | | |
| | portion and a second | | | |
| | protruding portion of a | | | |
| | center block in the tire | | | |
| | circumference direction | | | |
| | Presence of the bending | Yes | Yes | No |
| | portion in a shoulder | | | |
| | narrow groove | | | |
| Result | Wear-resistance | 100 | 109 | 106 |
| | properties | | | |
| | Uneven-wear-resistance | 100 | 111 | 104 |
| | properties | | | |
| | Traction properties | 100 | 101 | 100 |

What is claimed is:

1. A pneumatic tire comprising a plurality of main grooves extending in a tire circumference direction and a land portion interposed between the main grooves being segmentalized by a plurality of lateral grooves to form a plurality of blocks arranged in the tire circumference direction, wherein
the block includes a first protruding portion protruding from a portion on one side in a tire width direction to one side in the tire circumference direction and a second protruding portion protruding from a portion on the other side in the tire width direction to the other side in the tire circumference direction, and
the second protruding portion of the block on the one side and the first protruding portion of the block on the other side overlap with each other in the tire circumference direction between the blocks adjacent to each other in the tire circumference direction.

2. The pneumatic tire according to claim 1, wherein the block is provided with a narrow groove closed at both ends thereof, and the narrow groove is provided with a sipe formed on a groove bottom thereof.

3. The pneumatic tire according to claim 2, wherein the narrow groove overlaps with the first protruding portion and the second protruding portion in the tire circumference direction.

4. The pneumatic tire according to claim 1, wherein a shoulder land portion between the main groove and a tire ground contact end includes first shoulder blocks on the main groove side and second shoulder blocks on the tire ground contact end side arranged alternately in the tire circumference direction,
the first shoulder blocks each include a protruding portion protruding toward the second shoulder blocks, and
at least at the time of being grounded, the protruding portion of each of the first shoulder blocks overlaps in the tire circumference direction with the second shoulder blocks on both sides in the tire circumference direction, and the first shoulder block overlaps in the tire width direction with the second shoulder block on both sides in the tire circumference direction.

5. The pneumatic tire according to claim 1, wherein a depth of the lateral groove is not smaller than 70% of a depth of the main groove.

6. The pneumatic tire according to claim 1, wherein a depth of the narrow groove falls within a range from 5% to 20% of a depth of the main groove, and a depth of the sipe falls within a range from 40% to 90% of a depth obtained by subtracting the depth of the narrow groove from the depth of the main groove.
